(19) United States
(12) Patent Application Publication
(10) Pub. No.: US 2026/0351906 A1
(43) Pub. Date: Nov. 5, 2026

(54) Plug Connector Holder, Plug Connection, Vehicle and Method for Fastening an Electric Plug Connection

(71) Applicant: Bayerische Motoren Werke Aktiengesellschaft, Muenchen (DE)

(72) Inventors: Torsten HERZOG, Muenchen (DE); Michael KAINDL, Ergoldsbach (DE)

(21) Appl. No.: 19/484,090

(22) PCT Filed: May 7, 2024
(86) PCT No.: PCT/DE2024/100414

§ 371 Date: Nov. 13, 2025

(30) Foreign Application Priority Data
Jun. 27, 2023 (DE) 10 2023 116 839.8

(51) Int. Cl. H01R 13/73; H01R 13/6581

(52) U.S. Cl. CPC H01R 13/73; H01R 13/6581; H01R 2201/26

(57) ABSTRACT

A plug connector holder for holding a plug connector of an electric line of a vehicle where the plug connector holder extends in a longitudinal direction. The plug connector holder has a plug receiving portion with a receiving element for receiving the plug connector where the receiving element is metallically acting, at least in some portions, in order to shield the plug connector from an interference source, at least in some regions. The receiving element has a guide cutout for guiding the plug connector in the plug connector holder.

### BACKGROUND AND SUMMARY

The present invention relates to a plug connector holder, to an electric plug connection, to a vehicle and to a method for fastening an electric plug connection.

A modern vehicle can have a multiplicity of electric lines for distributing electric energy to components of the vehicle, and for transmitting data between components of the vehicle, and have a multiplicity of electric components, e.g., control apparatuses, wherein there is constant interest in minimizing the number of vehicle parts.

When distributing electric energy and/or transmitting data by means of electric lines, and when operating the components of the vehicle, electric, magnetic and/or electromagnetic fields can arise and cause undesirable interference which can compromise the functioning of the vehicle, or at least of individual components of the vehicle.

An electric line, in particular a data line, having two electric conductors can be used for transmitting data, wherein any mutual interference of the two electric conductors over a large length of the electric line can be reduced by twisting the two electric conductors. However, when connecting two electric lines by means of an electric plug connection, wherein each of the two electric lines has in each case at least two electric conductors, the respective two electric conductors are at least in portions not twisted on a respective end of a line of a respective electric line of the two electric lines. Thus, the electric line can disadvantageously be particularly susceptible to interferences in this portion, i.e., in the region of the electric plug connection.

It is an object of the present invention to at least partially eliminate the above-described disadvantages. It is in particular an object of the present invention to provide a plug connector holder by means of which an influence of an interference on individual electrically conducting “paths” or connections, or on at least an electric plug connector, is particularly minimized, and/or which is of a particularly simple design and/or is particularly cost-effective and/or particularly easy to assemble, in particular can be assembled in conjunction with at least two plug connectors disposed on one another as an electric plug connection on a vehicle. Furthermore, it is an object of the invention to provide a method by which an electric plug connection, in particular an electric plug connection of a vehicle, can be fastened to a mating fastening element, in particular to a vehicle, in a particularly simple and/or cost-effective and/or reliable manner.

It goes without saying that features and details herein which are described in the context of the plug connector holder according to the invention also apply in the context of the plug connection according to the invention and/or the vehicle and/or the method, and vice versa, respectively; therefore, reference in terms of the disclosure of the individual aspects of the invention is always made, or may be made, reciprocally.

According to a first aspect, the present invention shows a plug connector holder for holding at least one plug connector of an electric line of a vehicle, wherein the plug connector holder extends in a longitudinal direction, and wherein the plug connector holder has a plug receptacle portion having at least one receptacle element for receiving, in particular for receiving and holding in a force-fitting and form-fitting manner, the at least one plug connector, wherein at least the at least one receptacle element is at least in portions designed to be metallically acting in order to shield the at least one plug connector at least in regions in relation to at least one interference source, and wherein the at least one receptacle element has at least one guide gap for guiding the at least one plug connector, in particular for guiding a fastening element of the at least one plug connector, in the plug connector holder.

The term “metallically acting” is understood to mean that a material is used which is at least electrically conducting, or electrically conducting as well as magnetically conducting. An electrically conductive material is understood to mean in particular a material that has an electrical conductivity of at least 1*10⁵ S/m (Siemens per meter), in particular of at least 1*10⁶ S/m.

The at least one guide gap of the at least one receptacle element of the plug receptacle portion of the plug connector holder can also be understood to be a guide recess or a guide cut-out, in particular a guide slot. In particular, the at least one guide gap is designed to be rectilinear. In this way, a guide slot as the at least one guide gap can be particularly easily produced, for example by a separating method.

In particular, the plug receptacle portion of the at least one plug connector holder has a plurality of receptacle elements for receiving and holding a plurality of plug connectors of the vehicle, wherein in particular the plurality of receptacle elements are in each case at least in portions designed to be metallically acting in order to shield a respective plug connector of the plurality of plug connectors at least in regions. In particular, the plurality of plug connectors are associated with different electric plug connections. In other words, the plug connector holder can be designed in such a manner that the plug connector holder can hold plug connectors of a plurality of electric plug connections. For example, the plurality of receptacle elements can be disposed parallel to one another.

As a result of the design of the at least one receptacle element of the plug receptacle portion of the plug connector holder that is at least in portions metallically acting, the at least one plug connector, or respective individual electrically conducting “paths” or connections of an electric plug connection, can be particularly advantageously shielded in relation to electric and/or magnetic and/or electromagnetic fields of an interference source, in particular of an external interference source. As a result of the at least one guide gap, the at least one plug connector with a fastening element, for example in the shape of a pine cone, can be guided in the plug connector holder or holders, in particular in an inner receptacle space of the receptacle element. In this way, the at least one plug connector with the fastening element can be moved relative to the plug connector holder in the at least one guide gap of the at least one plug connector holder, in order to push the plug connector holder onto the at least one plug connector or a plurality of plug connectors disposed on one another, for example. Consequently, electrical shielding of respective individual electrically conducting “paths” or connections of the electric plug connection can take place, and furthermore the electric plug connection with the at least one plug connector, or a plurality of plug connectors disposed on one another, and with the plug connector holder to a mating fastening element, for example to a mating fastening element of a vehicle, can take place in a particularly simple manner.

In a plug connector holder according to the invention, it can be advantageous that the at least one receptacle element has an opening which is configured to be continuous in the longitudinal direction of the plug connector holder, so as to form an inner receptacle space for receiving the at least one plug connector, wherein the at least one receptacle element has the at least one guide gap on a jacket side of the at least one receptacle element. In this way, the at least one plug connector can be particularly advantageously received and shielded by the at least one receptacle element. For example, the at least one receptacle element having the opening configured to be continuous in the longitudinal direction of the plug connector holder is designed in the manner of a hollow body. In this way, the at least one plug connector, or respective individual electrically conducting “paths” or connections of an electric plug connection, can be particularly advantageously shielded. In particular, the at least one guide gap in the receptacle element designed in the manner of a hollow body extends, proceeding from an end side of the receptacle element designed in the manner of a hollow body, at least in portions in the longitudinal direction, or substantially in the longitudinal direction, of the plug connector holder. In this way, it is particularly easy to push the plug connector holder on in the longitudinal direction of the at least one plug connector.

In a plug connector holder according to the invention it can be advantageous that the at least one receptacle element extends in an encircling direction about the longitudinal direction of the plug connector holder in such a manner that the at least one receptacle element is mouth-shaped with a mouth opening, and forms the inner receptacle space for receiving the at least one plug connector. In this way, the at least one plug connector can be introduced into the inner receptacle space of the at least one receptacle element by way of the mouth opening. In particular, introducing the at least one plug connector, or two plug connectors disposed on one another, is performed transversely, or substantially transversely, to the longitudinal direction of the plug connector holder by way of the mouth opening of the at least one receptacle element. It is additionally conceivable that the plug receptacle portion has a covering member, in particular a foldable covering member, and/or a covering member which is able to be fastened in a force-fitting and form-fitting manner, so as to at least partially cover the mouth opening, wherein the covering member is at least in portions designed to be metallically acting, preferably so as to be completely metallically acting, in order to at least in regions additionally shield the at least one plug connector. In this way, the at least one plug connector can be particularly advantageously shielded in relation to electric and/or magnetic and/or electromagnetic fields of an interference source, in particular of an external interference source. For example, after introducing the electric plug connection, the covering member can be disposed over the mouth opening. In particular, the at least one guide gap in the mouth-shaped receptacle element extends, proceeding from a first mouth end of the mouth-shaped receptacle element, at least in portions transversely, or substantially transversely, to the longitudinal direction of the plug connector holder. In this way, the at least one plug connector with the fastening element can be introduced transversely, or substantially transversely, to the longitudinal direction of the plug connector holder by way of the mouth opening and the guide gap into the inner receptacle space of the at least one receptacle element. In particular, the mouth-shaped receptacle element is designed to be U-shaped, or substantially U-shaped, in cross section, having a first leg, a second leg opposite the first leg, and a base which connects the first leg and the second leg. A “mouth end” herein can be understood to mean an end of the first leg or of the second leg that faces away from the base.

In a plug connector holder according to the invention it can be advantageous that the at least one guide gap is open on at least one side, in particular is open on only one side. In other words, the at least one guide gap can be an open guide gap, in particular a guide gap only open on one side. In this way, the at least one plug connector can be preassembled with the at least one fastening element, or the at least one fastening element can be configured integrally with the plug connector such that the at least one plug connector, conjointly with the at least one fastening element, i.e., as a unit, can be introduced into the inner receptacle space of a mouth-shaped plug connector holder, for example.

In a plug connector holder according to the invention it can be advantageous that the at least one guide gap extends so as to be inclined at least in portions, preferably so as to be transverse at least in portions, relative to the longitudinal direction of the plug connector holder, and/or extends at least in portions in the longitudinal direction of the plug connector holder. In a guide gap which extends at least in portions in the longitudinal direction of the plug connector holder, the plug connector holder can be configured in the manner of a hollow body, and the shielding of the at least one plug connector can be particularly advantageous. In a guide gap which extends at least in portions transversely to the longitudinal direction of the plug connector holder, moving the at least one plug connector in the longitudinal direction of the plug connector holder can particularly advantageously be minimized, in particular prevented. In this way, shielding of the at least one plug connector can be particularly advantageously ensured. It is also conceivable that the at least one guide gap extends at least in portions transversely to the longitudinal direction of the plug connector holder, and at least in portions in the longitudinal direction of the plug connector holder. In this way, it can be particularly advantageously minimized, in particular prevented, that the plug connector holder and the at least one plug connector are unintentionally released from one another or disassembled.

In a plug connector holder according to the invention it can be advantageous that the at least one receptacle element has at least one holding element for holding the at least one received plug connector. In this way it can be particularly advantageously minimized, in particular prevented, that the plug connector holder and the at least one plug connector are unintentionally released from one another or disassembled. The at least one holding element can have at least one stop or a plurality of stops. In particular, the plurality of stops in the at least one receptacle element are disposed in such a manner that the at least one received plug connector is fixed, in particular without play, or substantially without play, at least in one direction of extent of the at least one guide gap. For example, in a mouth-shaped receptacle element which is U-shaped or substantially U-shaped in cross section, and wherein the at least one guide gap extends transversely or substantially transversely to the longitudinal direction of the plug connector holder, a base of the mouth-shaped receptacle element can form a first stop, and a corrugation (in the height direction) formed on a first mouth end and/or a corrugation (in the height direction) formed on a second mouth end can form a second stop.

In a plug connector holder according to the invention it can be advantageous that the at least one receptacle element for receiving the at least one plug connector is produced integrally from a metallically acting material, in particular is produced integrally from a metallically acting material and is elastically deformable. In this way, a plug connector holder can be produced in a particularly cost-effective manner. In particular, the plug receptacle portion with the at least one receptacle element is produced integrally from a metal, for example from iron, in particular spring steel, aluminum, or brass. Furthermore, the at least one metallic receptacle element can have a protective layer, for example a plastics-material protective layer, which is applied to the metal. In this way, direct contact between the at least one metallic receptacle element and the at least one plug connector can be avoided. It is furthermore conceivable that the plug connector holder is an injected-molded plastic part, wherein at least the at least one receptacle element of the plug receptacle portion of the plug connector holder has a metallically acting body, in particular a metallic body, for example a metal plate and/or a metal mesh, which is at least in portions overmolded with plastics material, in order to shield the at least one plug connector at least in portions. Alternatively, it is also conceivable that the at least one receptacle element, in particular the plug connector holder, is an integral plastics-material part which is produced, in particular injection-molded, from a metallically acting plastics material.

According to a second aspect, the present invention shows a plug connection, in particular an electric plug connection, for a vehicle, wherein the plug connection has at least one first plug connector and one second plug connector, wherein the at least one first plug connector is disposed on the second plug connector, and wherein the first plug connector has a fastening portion with at least one fastening element for fastening to a mating fastening element of the vehicle. Furthermore, the plug connection comprises at least one plug connector holder, wherein the at least one plug connector holder is configured according to the invention, in particular as has already been described with reference to the first aspect of the invention. Furthermore, in the plug connection, at least the first plug connector and/or the second plug connector are/is received by the at least one receptacle element of the plug receptacle portion of the plug connector holder, in particular received and held in a force-fitting and form-fitting manner, and wherein the at least one fastening element of the fastening portion of the first plug connector is at least guided, in particular without play or substantially without play, in the at least one guide gap of the at least one receptacle element of the plug receptacle portion of the plug connector holder.

In particular, the at least one fastening element of the fastening portion of the first plug connector that is guided in the at least one guide gap extends away from the at least one plug connector holder. In other words, the at least one fastening element of the fastening portion of the first plug connector can extend beyond the at least one plug connector holder so as to be able to fasten, preferably in a force-fitting and form-fitting manner, the plug connection by means of the at least one fastening element to the mating fastening element of the vehicle, for example to a vehicle body with a fastening bore.

In particular, the at least one fastening element can be releasably disposed on the first plug connector. For this purpose, the at least one fastening element and the first plug connector can have mutually corresponding disposal portions for connecting in a force-fitting and form-fitting manner the at least one fastening element to the first plug connector. In this way, different fastening elements for differently configured mating fastening elements can be disposed in a particularly simple manner. For example, the first plug connector can have a dovetail groove or a trapezoidal groove, and the at least one fastening element can have a disposal portion configured in a corresponding manner, or a threaded connection, a bayonet connection, a snap-fit connection and/or a clamping connection can be configured. It is also conceivable that the at least one fastening element is non-releasably disposed on the first plug connector; a welded connection, riveted connection and/or adhesively bonded connection can be configured, for example. Alternatively, it is also conceivable that the at least one fastening element is configured integrally with the first plug connector, for example in the case of an injection-molded plastic part. In this way, an additional assembly step for a separately produced fastening element on the first plug connector can be dispensed with.

In the plug connection according to the invention it can be advantageous that the metallically acting portion of the at least one receptacle element of the plug receptacle portion extends in the longitudinal direction of the at least one plug connector holder over at least 50% of the length of the electric plug connection, preferably over at least 70% of the length of the electric plug connection, most preferably over at least 90% of the length of the electric plug connection. In this way, the first plug connector and/or the second plug connector, or the electric plug connection, can be particularly advantageously shielded in relation to electric and/or magnetic and/or electromagnetic fields of an interference source, in particular of an external interference source. In a plug connection according to the invention it can furthermore be advantageous that the metallically acting portion of the at least one receptacle element of the plug receptacle portion extends in the encircling direction about the longitudinal direction of the plug connector holding in such a manner that at least 50% of the circumference of the electric plug connection, preferably at least 70% of the circumference of the electric plug connection, most preferably at least 90% of the circumference of the electric plug connection, are encompassed. In this way, the first plug connector and/or the second plug connector, or the electric plug connection, can be particularly advantageously shielded in relation to electric and/or magnetic and/or electromagnetic fields of an interference source, in particular of an external interference source.

The plug connection according to the second aspect of the invention thus has the same advantages as have already been described with reference to the plug connector holder according to the first aspect of the invention.

According to a third aspect, the present invention shows a vehicle, wherein the vehicle has at least one plug connector holder configured according to the invention.

The vehicle is in particular a motor vehicle, preferably a passenger motor vehicle, a motor truck or a motor bicycle, for example a motorcycle.

The mating fastening element of the vehicle can be a fastening bore, or a vehicle component, for example a vehicle body, with a fastening bore leading from a front side of the mating fastening element, facing the plug connector holder, to a rear side of the mating fastening element, opposite the front side, wherein the at least one fastening element of the fastening portion of the first plug connector is designed in such a manner that the at least one fastening element by means of the fastening bore engages behind, or can engage behind, the mating fastening element on the rear side of the mating fastening element, so as to hold or fasten, in particular hold or fasten in a force-fitting and form-fitting manner, the plug connector holder on and/or at the front side of the mating fastening element.

The vehicle according to the third aspect of the invention thus has the same advantages as have already been described with reference to the plug connector holder according to the first aspect of the invention, or the plug connection according to the second aspect of the invention.

According to a fourth aspect, the present invention shows a method for fastening an electric plug connection to a mating fastening element, in particular to a mating fastening element of a vehicle. The method comprises as a step providing at least one first plug connector and one second plug connector configured to correspond to the first plug connector, wherein at least the first plug connector has a fastening portions with at least one fastening element for fastening to the mating fastening element. Furthermore, the method comprises as a step providing at least one plug connector holder, wherein the at least one plug connector holder is configured according to the invention. Furthermore, the method comprises as a step disposing the first plug connector on the second plug connector. Furthermore, the method comprises as a step fastening the two plug connectors disposed on one another to the mating fastening element, in particular the mating fastening element of the vehicle, by means of the at least one fastening element of the fastening portion of the first plug connector. Furthermore, the method comprises as a step moving the first plug connector with the fastening element of the fastening portion of the first plug connector in the at least one guide gap of the at least one plug connector holder relative to at least one plug connector holder in order to push on the plug connector holder.

The method steps described above and hereunder can be carried out individually, conjointly, once, multiple times, chronologically parallel and/or successively in any order, if technically expedient. A preferred order of the method steps provides that the two plug connectors and the at least one plug connector holder are provided, and the two plug connectors, i.e., the first plug connector and the second plug connector, are disposed on one another, in particular plugged into one another. Subsequently, the two plug connectors disposed on one another with the at least one fastening element of the fastening portion of the first plug connector can be fastened to the mating fastening element, wherein after fastening to the mating fastening element the at least one plug connector holder with the at least one guide gap is moved relative to the first plug connector with the fastening element in order to push the plug connector holder onto the two plug connectors disposed on one another. Alternatively, after disposing the two plug connectors on one another, in particular after plugging the two plug connectors into one another, the at least one plug connector holder with the at least one guide gap can chronologically first be moved relative to the first plug connector with the fastening element in order to push the plug connector holder onto the two plug connectors disposed on one another, wherein subsequently the two plug connectors received by the plug connector holder, conjointly with the plug connector holder with the at least one fastening element of the fastening portion of the first plug connector, are fastened to the mating fastening element.

By moving the first plug connector with the fastening element of the fastening portion of the first plug connector in the at least one guide gap of the at least one plug connector holder relative to the at least one plug connector holder in order to push on the plug connector holder, the first plug connector is transferred to a holding position, wherein the received first plug connector is held in the holding position, in particular is held in a force-fitting and form-fitting manner by at least one holding element of the at least one receptacle element of the plug receptacle portion of the plug connector holder.

The method according to the fourth aspect of the invention thus has the same advantages as have already been described with reference to the plug connector holder according to the first aspect of the invention, or the plug connection according to the second aspect of the invention, or the method according to the third aspect of the invention.

Further measures improving the invention are derived from the description hereunder of some exemplary embodiments of the invention, which are schematically illustrated in the figures. All of the features and/or advantages, including structural details, spatial arrangements and method steps, which are derived from the claims, the description or the drawings can be relevant to the invention individually as well as in the various combinations. It is to be noted that the figures are only descriptive and are not intended to limit the invention in any way.

### BRIEF DESCRIPTION OF THE DRAWINGS

FIG. 1 schematically shows a plug connector holder;

FIG. 2 schematically shows a fastened plug connection;

FIG. 3 schematically shows a vehicle; and

FIG. 4 schematically shows a method.

### DETAILED DESCRIPTION OF THE DRAWINGS

In the figures hereunder, identical reference signs are used for the same technical features even in different exemplary embodiments.

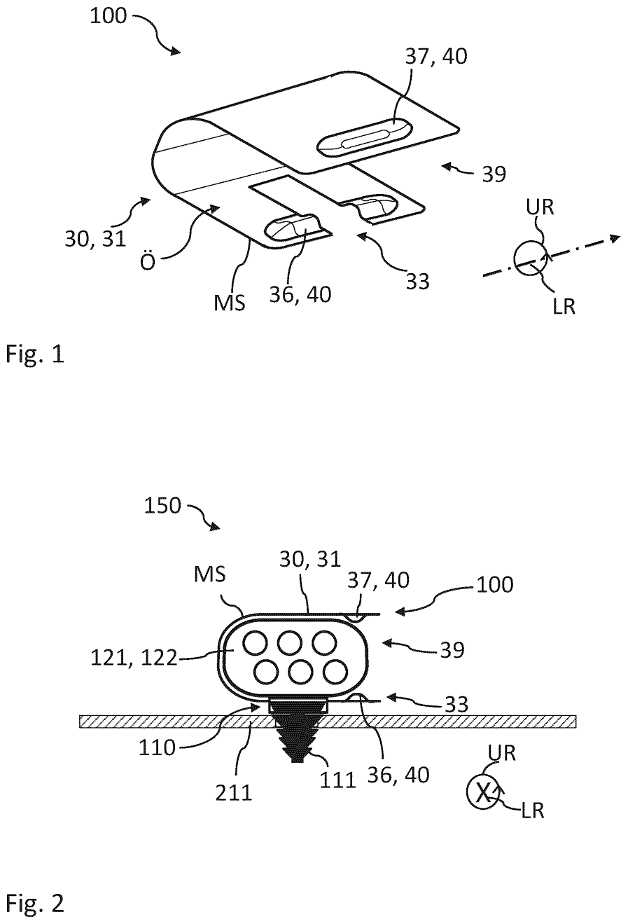

FIG. 1 discloses in a perspective view a plug connector holder (100) for holding at least one plug connector (121, 122) of an electric line (131, 141) of a vehicle (200). By way of example, the plug connector holder (100) is designed to be U-shaped, or substantially U-shaped, and is produced, for example, integrally from a metal sheet by forming steps and/or separating steps. The plug connector holder (100) extends in a longitudinal direction (LR), and wherein the plug connector holder (100) has a plug receptacle portion (30) with at least one receptacle element (31) for receiving the at least one plug connector (121, 122). The at least one receptacle element (31) is at least in portions designed to be metallically acting in order to shield the at least one plug connector (121, 122) at least in regions in relation to at least one interference source, and wherein the at least one receptacle element (31) has at least one guide gap (33) for guiding the at least one plug connector (121, 122) in the plug connector holder (100). To facilitate the introduction of the fastening element (111) of the at least one plug connector (121, 122), the at least one guide gap (33) can be beveled. Furthermore, the at least one receptacle element (31) comprises an opening (Ö) which is configured to be continuous in the longitudinal direction (LR) of the plug connector holder (100), so as to form an inner receptacle space for receiving the at least one plug connector (121, 122), wherein the at least one receptacle element (31) has the at least one guide gap (33) on a jacket side (MS) of the at least one receptacle element (31). The at least one receptacle element (31) extends in an encircling direction (UR) about the longitudinal direction (LR) of the plug connector holder (100) in such a manner that the at least one receptacle element (31) forms a mouth shape with a mouth opening (39) and the inner receptacle space for receiving the at least one plug connector (121, 122). By way of example, the at least one guide gap (33) extends transversely, or substantially transversely, to the longitudinal direction (LR) of the plug connector holder (100) and is open at a first mouth end of the mouth-shaped receptacle element (31), i.e., is open on one side, such that the at least one plug connector (121) with at least one fastening element (111) of a fastening portion (110) (see FIG. 2, for example) can be guided in the plug connector holder (100), in particular be guided to a holding position, for fastening to a mating fastening element (211), for example to a mating fastening element (211) of a vehicle (200).

In the plug connector holder (100) illustrated in FIG. 1 it can be advantageous when the at least one receptacle element (31) has at least one holding element (40) for holding the at least one received plug connector (121, 122) and is advantageously elastically deformable. In the mouth-shaped receptacle element (31), which by way of example is U-shaped, or substantially U-shaped, in cross section, with a first leg, a second leg and a base, and wherein the at least one guide gap (33) by way of example extends transversely, or substantially transversely, to the longitudinal direction of the plug connector holder, the base of the mouth-shaped receptacle element (31) can form a first stop, and a corrugation (in the height direction) which is formed on a first mouth end, or on the first leg, and produced, for example, by a forming step, and/or a corrugation (in the height direction) which is formed on a second mouth end, or the second leg, and is produced, for example, by a forming step, can form a second stop. The corrugations can additionally contribute to the shielding effect. The at least one plug connector (121, 122), or two plug connectors (121, 122) plugged into one another, can thus be introduced laterally, i.e., transversely to the longitudinal direction (LR), by way of the mouth opening (39) of the mouth-shaped receptacle element (31) into the inner receptacle space, wherein the mouth-shaped receptacle element (31), due to the elastic deformation capability, can expand and contracts again after the at least one plug connector (121) has been completely introduced, in order to hold the at least one plug connector (121, 122), or two plug connectors (121, 122) plugged into one another, along the direction of the extent of the guide gap (33).

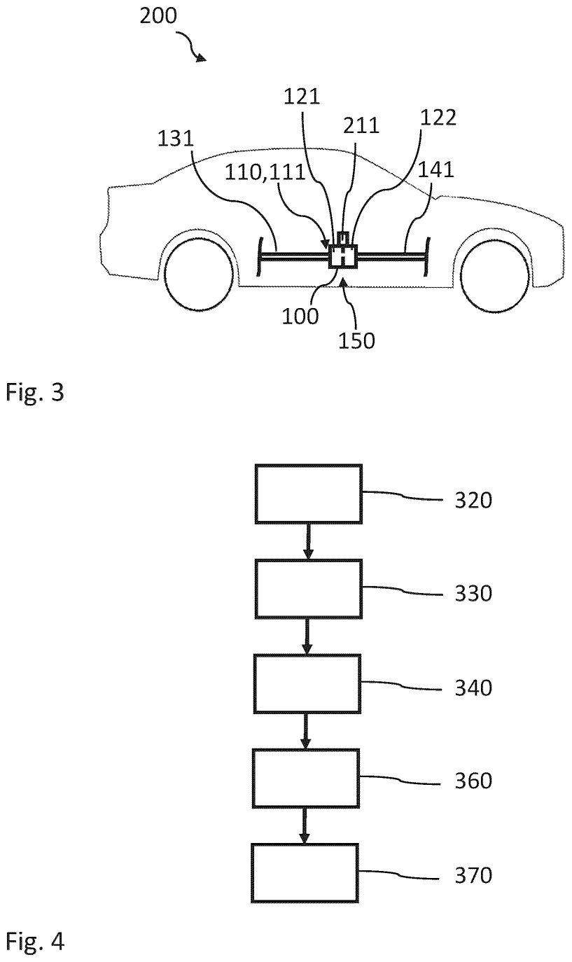

FIG. 2 in a lateral view schematically discloses a plug connection (150) for a vehicle (200) as described with reference to FIG. 3, for example, wherein the plug connection (150) has at least one first plug connector (121) and one second plug connector (122). The first plug connector (121) can be electrically connected to a first electric line (131), and the second plug connector (122) can be electrically connected to a second electric line (141). The at least one first plug connector (121) is disposed on the second plug connector (122), and wherein at least the first plug connector (121) has a fastening portion (110) with at least one fastening element (111) for fastening to a mating fastening element (211) of the vehicle (200), for example to a body having a fastening bore. Furthermore, the plug connection (150) comprises at least one plug connector holder (100), wherein the at least one plug connector holder (100) is configured according to the invention, for example as has been described with reference to FIG. 1. Furthermore, at least the first plug connector (121), or the first plug connector (121) and the second plug connector (122), is/are received by the at least one receptacle element (31) of the plug receptacle portion (30) of the plug connector holder (100), and wherein the at least one fastening element (111) of the fastening portion (110) of the first plug connector (121) is at least guided in the at least one guide gap (33) of the at least one receptacle element (31) of the plug receptacle portion (30) of the plug connector holder (100). The at least one fastening element (111) of the fastening portion (110) of the first plug connector (121) is in particular configured and guided in such a manner that it blocks or prevents the received first plug connector (121) moving perpendicularly, or substantially perpendicularly, to the direction of extent of the guide gap (33) and/or to the longitudinal direction (LR) of the plug connector holder (100). In FIG. 2, the two plug connectors (121, 122) which are received by the plug connector holder (100) are furthermore, conjointly with the plug connector holder (100) with the at least one fastening element (111) of the fastening portion (100) of the first plug connector (121), fastened in a force-fitting and form-fitting manner to the mating fastening element (211), for example by means of a self-locking fastening element (111) in the shape of a pine cone.

FIG. 3 in a lateral view schematically discloses a vehicle (300), wherein the vehicle (300) has at least one plug connection (150) according to the invention, as has been described with reference to FIG. 2, for example.

FIG. 4 schematically discloses a method for fastening an electric plug connection (150) to a mating fastening element (211), in particular to a mating fastening element (211) of a vehicle (200), as has been described with reference to FIG. 3, for example. Preferably, the two plug connectors (121, 122) and the at least one plug connector holder (100) are provided (320, 330), and the two plug connectors (121, 122), i.e., the first plug connector (121) and the second plug connector (122), are disposed on one another (340), in particular plugged into one another. Subsequently, the two plug connectors (121, 122) which are disposed on one another, with the at least one fastening element (111) of the fastening portion (110) of the first plug connector (121) can be fastened (360) to the mating fastening element (211), wherein chronologically after the fastening (360) of the two plug connectors (121, 122) to the mating fastening element (211) (or alternatively chronologically before the fastening (360) of the two plug connectors (121, 122) to the mating fastening element (211)), the at least one plug connector holder (100) with the at least one guide gap (33) is moved (370) relative to the first plug connector (121) with the fastening element (111), in order to push the plug connector holder (100) onto the two plug connectors (121, 122) which are disposed one another. The pushed-on plug connector holder (100) can thus be transferred to a holding position in which the latter is held in a force-fitting and form-fitting manner.

### List of Reference Characters

30 Plug receptacle portion
31 Receptacle element
33 Guide gap
36 First corrugation
37 Second corrugation
39 Mouth opening
40 Holding element
100 Plug connector holder
110 Fastening portion
111 Fastening element
121, 122 Plug connector
131, 141 Electric line
150 Electric plug connection
200 Vehicle
211 Mating fastening element
LR Longitudinal direction plug connector holder
UR Encircling direction
MS Jacket side

1.-10. (canceled)

11. A plug connector holder for holding a plug connector of an electric line of a vehicle, comprising:
a plug receptacle portion having a receptacle element for receiving the plug connector;
wherein the plug connector holder extends in a longitudinal direction of the plug connector holder;
wherein the receptacle element is at least in a portion configured to be metallically acting in order to shield the plug connector at least in a region in relation to an interference source;
wherein the receptacle element has a guide gap for guiding the plug connector in the plug connector holder.

12. The plug connector holder according to claim 11, wherein the receptacle element has an opening which is continuous in the longitudinal direction of the plug connector holder such that an inner receptacle space for receiving the plug connector is formed and wherein the receptacle element has the guide gap on a jacket side of the receptacle element.

13. The plug connector holder according to claim 12, wherein the receptacle element extends in an encircling direction about the longitudinal direction of the plug connector holder such that the receptacle element is mouth-shaped with a mouth opening and forms the inner receptacle space.

14. The plug connector holder according to claim 11, wherein the guide gap is open on one side.

15. The plug connector holder according to claim 11, wherein the guide gap extends so as to be inclined at least in a portion relative to the longitudinal direction of the plug connector holder and/or extends at least in a portion in the longitudinal direction of the plug connector holder.

16. The plug connector holder according to claim 11, wherein the receptacle element has a holding element for holding the plug connector.

17. The plug connector holder according to claim 11, wherein the receptacle element is produced integrally from a metallically acting material and wherein the receptacle element is elastically deformable.

18. A plug connection for a vehicle, comprising:
a first plug connector and a second plug connector, wherein the first plug connector is disposed on the second plug connector and wherein the first plug connector has a fastening portion having a fastening element for fastening to a mating fastening element; and
the plug connector holder according to claim 11;
wherein the first plug connector and/or the second plug connector are/is received by the receptacle element of the plug receptacle portion of the plug connector holder;
wherein the fastening element of the fastening portion of the first plug connector is guided in the guide gap of the receptacle element of the plug receptacle portion of the plug connector holder.

19. A method for fastening an electric plug connection to a mating fastening element of a vehicle, comprising the steps of:
providing a first plug connector and a second plug connector, wherein the first plug connector has a fastening portion with a fastening element for fastening to the mating fastening element;
providing the plug connector holder according to claim 11;
disposing the first plug connector on the second plug connector;
fastening the first plug connector and the second plug connector that are disposed on one another to the mating fastening element by the fastening element of the fastening portion of the first plug connector; and
moving the first plug connector with the fastening element of the fastening portion of the first plug connector in the guide gap of the plug connector holder relative to the plug connector holder in order to push on the plug connector holder.
